(19) United States
(12) Patent Application Publication
(10) Pub. No.: US 2007/0300271 A1
(43) Pub. Date: Dec. 27, 2007

(54) Dynamic triggering of media signal capture

(76) Inventors: Geoffrey Benjamin Allen, Potomac Falls, VA (US); Steven Lee Geyer, Herndon, VA (US)

Correspondence Address: COOLEY GODWARD KRONISH LLP;ATTN: PATENT GROUP, Suite 1100, 777 - 6th Street, NW, WASHINGTON, DC, 20001, US

(21) Appl. No.: 11/473,060

(22) Filed: Jun. 23, 2006

(51) Int. Cl. H04N 7/173

(52) U.S. Cl. 725/93

(57) ABSTRACT

In one embodiment, a method includes associating a dynamic capture parameter with a capture record included in a capture schedule. A capture instruction is defined based on the dynamic capture parameter and the capture record. The capture instruction is configured to cause a multimedia capture device to capture a media signal after the capture instruction is received at the multimedia capture device.

### FIELD OF INVENTION

The invention relates generally to an apparatus and method for media signal capture, including, for example, a method for dynamically triggering the capture of media signals on a multimedia capture device.

### BACKGROUND

The ability to capture live media recordings of, for example, scheduled classroom instruction or scheduled meetings for on-demand availability and time-shifted viewing has become valuable to institutions such as universities and businesses. But, capturing all aspects of, for example, a scheduled business meeting may not be desirable, necessary, and/or possible. For example, a speaker may only want audio of a classroom presentation to be captured because slides and/or a chalkboard will not be used during the course of the presentation. Capturing, processing, and distributing video captured of the unused/blank chalkboard during the entire presentation may be an inefficient use of resources. Even if the capturing of a video stream of the presentation was required because slides were to be presented, a low resolution video stream, for example, may adequately capture the content of the slides. In some instances, a device intended for capturing the content of the presentation may not be capable of, for example, capturing video at all.

Thus, a need exists for an apparatus and method for defining parameters for capturing a live media recording.

### SUMMARY OF THE INVENTION

In one embodiment, a method includes associating a dynamic capture parameter with a capture record included in a capture schedule. A capture instruction is defined based on the dynamic capture parameter and the capture record. The capture instruction is configured to cause a multimedia capture device to capture a media signal after the capture instruction is received at the multimedia capture device.

### BRIEF DESCRIPTION OF THE DRAWINGS

FIG. 1 is a block diagram that illustrates multimedia capture devices distributed across a network and coupled to a control server, according to an embodiment of the invention.

FIG. 2 shows a flowchart that illustrates a method for defining a capture instruction, according to an embodiment of the invention.

FIG. 3 illustrates an example of a priority table that can be used to define a capture instruction, according to an embodiment of the invention.

FIG. 4 illustrates an example of a speaker preference being associated with a capture record, according to an embodiment of the invention.

FIG. 5 is a system block diagram that illustrates a multimedia capture device, according to an embodiment of the invention.

### DETAILED DESCRIPTION

A multimedia capture device is a device configured to capture, process, store and/or send real-time media signals (e.g. audio signal, video signal, visual-capture signal, and/or digital-image signal) of, for example, an in-progress classroom presentation. The multimedia capture device can be, for example, an embedded appliance dedicated to real-time media signal capture or a general purpose computer system configured for real-time media signal capture. A real-time media signal represents an image and/or a sound of an event that is being acquired by a sensor (i.e., media sensor) at substantially the same time as the event is occurring and that is transmitted without a perceivable delay between the sensor when acquired and the multimedia capture device when received. Real-time media signals are also referred to herein as media signals for convenience.

One or more multimedia capture devices can be configured to capture one or more media signals from a venue based on a capture schedule. The capturing of the media signals at a multimedia capture device according to the capture schedule can be triggered by a capture instruction(s). The capture instruction(s) can be defined and associated with a multimedia capture device based on a capture record in the capture schedule. The capture instruction(s) can also be defined based on one or more dynamic capture parameters (e.g., user defined preference) and/or fixed attributes (e.g., physical limitation of a device or venue) that can be associated with the capture record. The dynamic capture parameters and/or fixed attributes can be associated with more than one capture record from the capture schedule based on one or more identifiers. The capture instruction can also include parameters to cause a multimedia capture device to, for example, process a captured media signal (e.g., compress the media signal in a specified format).

Because dynamic capture parameters and/or fixed attributes can be received, modified and/or stored at the multimedia capture device and/or the control server, a capture instruction(s) can be defined at the multimedia capture device and/or the control server. Capture instructions can be dynamically modified at the multimedia capture device and/or the control server based on additional and/or modified dynamic capture parameters, capture records, and/or fixed attributes. The capture instructions can be defined and/or modified based on, for example, a rules-based algorithm (e.g., priority table).

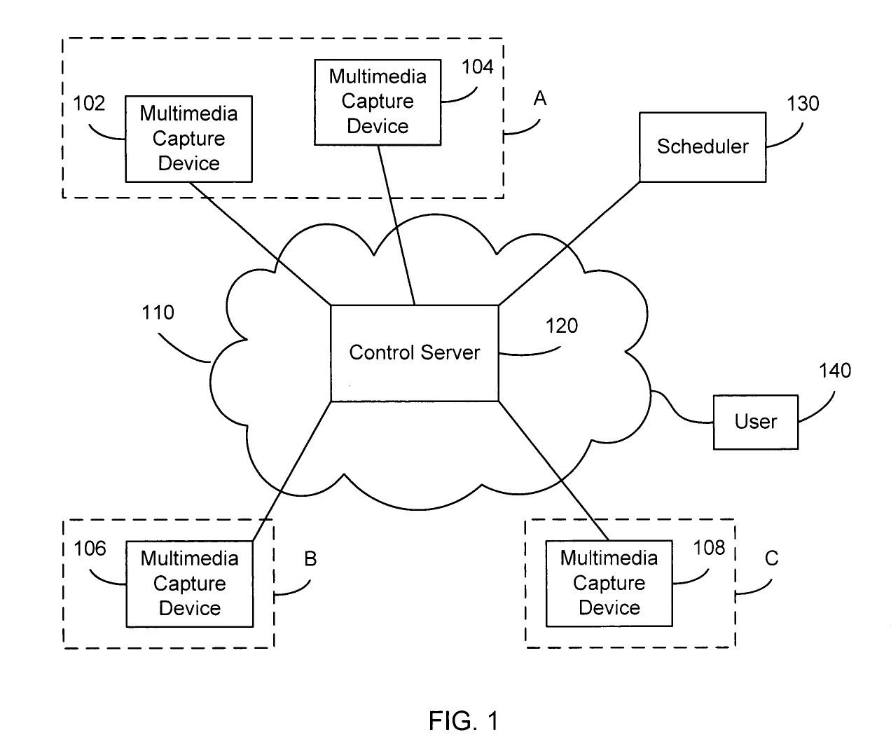

FIG. 1 is a block diagram that illustrates multimedia capture devices 102-108 distributed across a network 110 and coupled to a control server 120. The network 110 can be any type of network including a local area network (LAN) or wide area network (WAN) implemented as a wired or wireless network in a variety of environments such as, for example, an office complex or a university campus. Each of the multimedia capture devices 102-108 are associated with one of the venues A, B or C (also referred to as locations). Multimedia capture devices 102 and 104 are associated with venue A; multimedia capture devices 106 and 108 are associated with venues B and C, respectively. Each of the venues can be, for example, a classroom within a university or a conference room within an office.

The multimedia capture devices 102-108 are configured to capture one or more media signals that include, for example, an audio signal(s), a video signal(s), a visual-capture signal(s), and/or a digital-image signal(s) via a media sensor(s) (e.g., microphone, video camera) located within their respective venues A, B or C. The multimedia capture devices 102-108 are triggered by one or more capture instructions. For example, a capture instruction can be defined to cause/trigger, for example, multimedia capture device 108 to capture one or more media signals representing images and/or sound acquired via one or more specified media sensors during a specific time period from a specified venue (e.g., venue C). The capture instruction can be defined to trigger directly the capturing of a media signal(s) at multimedia capture device 108 when the capture instruction is received or the capture instruction can be defined so that multimedia capture device 108 can use the capture instruction to schedule the capturing of a media signal(s) at a different time (e.g., a time specified by the capture instruction).

The capture instruction(s) is defined based on a capture schedule that includes start time indicators, stop time indicators, and venue indicators that can collectively be used as indicators of times and venues for capturing media signal(s) by the multimedia capture devices 102-108. The start time indicators, stop time indicators, and venue indicators are included in one or more capture records within the capture schedule. In this embodiment, the venue indicators of the capture schedule correspond to at least one of venues A, B or C. The capture schedule can be configured so that the start time indicators and/or stop time indicators can specify not only a time of day, but also, for example, a day of a week and/or a specific date. The stop time indicator can be derived based on a time period (e.g., duration) that starts at the start time indicator and is included in, for example, a capture record within the capture schedule

The start/stop time indicators within the capture schedule are used to define start capture indicators and/or stop capture indicators within the capture instruction(s). The venue indicators within the capture schedule are used to associate the capture instruction with one or more of the multimedia capture devices 102-108. Because the multimedia captures devices 102 108 are associated with at least one of the venues A, B or C, capture instructions are produced based on capture records that specify a venue can be associated with one or more of the multimedia capture devices 102-108. In some embodiments, a capture record and/or a capture instruction can be associated with one of the multimedia capture devices 102-108 using a table that associates each of the multimedia capture devices 102-108 with at least one of the venues A, B or C.

As shown in FIG. 1, the control server 120 is coupled to a scheduler 130. The scheduler 130 is configured to transmit the capture schedule with one or more capture records to the control server 120. The capture schedule can be equivalent to or can be derived from, for example, a class schedule at a university that specifies class times, class durations, and locations. Each of the records within the class schedule that specifies a class time (e.g., start time indicator), duration (e.g., used to derive a stop time indicator), and location (e.g., venue) can be used and/or identified by the control server 120 and/or the scheduler 130 as a capture record.

The control server 120 can be configured to receive and/or request one or more portions of the capture schedule from the external scheduler 130, for example, periodically or when the capture schedule is modified. Likewise, the external scheduler 130 can be configured to send portions of the capture schedule to the control server 120 when, for example, the capture schedule is modified (e.g., updated). The scheduler 130 can be, for example, a server or a remote computer that contains the capture schedule.

Although FIG. 1 shows that the scheduler 130 is coupled to the control server 120, in some embodiments, the scheduler 130 can be configured to send one or more portions of a capture schedule(s) to each of the multimedia capture devices 102-108. In some embodiments, the scheduler 130 can be configured to send only relevant portions of a capture schedule (e.g., specific capture record(s)) to one or more of the multimedia capture devices 102-108. For example, the scheduler 130 can be configured to send capture records associated with venue C to multimedia capture device 108. In many embodiments, the functionality of the scheduler 130 can be integrated into the control server 120.

The capture instruction(s) can also be associated with and defined based on one or more dynamic capture parameters. The dynamic capture parameters are defined and/or modified dynamically by a user/administrator without a significant reconfiguration of hardware and/or software in, for example, a device. The dynamic capture parameters can also be based on a measurement (e.g., measured dynamically without a significant reconfiguration of hardware and/or software). The dynamic capture parameters can be used, in addition to, or in place of, a portion of the capture record when defining one or more parameters within a capture instruction. For example, a capture record within a capture schedule can be used to define the capture start/stop times and venue within a capture instruction and a dynamic capture parameter such as a speaker preference, for example, can be used to further define the capture instruction to trigger, for example, the capturing of a specified type of media signal (e.g., video signal) at a specific bit rate using a specified device (e.g., web camera) and/or input port (e.g., digital-image input port).

The capture instruction(s) can also be associated with and defined based on one or more fixed attributes that cannot be dynamically modified (i.e., cannot be modified without a reconfiguration of hardware and/or software). A fixed attribute can, for example, include a capture device hardware configuration or a venue set-up (e.g., camera placement). Because a fixed attribute can be associated with or can be an indicator of a physical limitation of, for example, a multimedia capture device, the fixed attribute can have priority over a dynamic capture parameter when defining a capture instruction. For example, even if a speaker preference explicitly calls for the capturing of a video signal during a specified time period based on a capture record, a capture instruction defined for that time period based on the capture record will exclude the capturing of the video signal if venue C is not configured with a media sensor capable of acquiring video.

Each of the multimedia capture devices 102-108, although associated with a specific venue in this embodiment, can include a unique identifier (e.g., internet protocol (IP) address) that can be used to distinguish one multimedia capture device from another, even if physically and/or virtually included in the same venue (e.g., two devices included in a single virtual venue even though the devices are physically in separate locations). For example, a unique identifier associated with multimedia capture device 102 can be used to define a capture instruction for multimedia capture device 102 even though multimedia capture device 104 is also in venue A.

More than one capture instruction can be defined in a coordinated fashion if, for example, the capture instructions are defined for more than one multimedia capture device in, for example, a single venue. If, for example, a capture record within the capture schedule specifies that a business meeting will be held at a specified time at venue A, the control server 120 can be configured to define and/or send a first capture instruction to multimedia capture device 102 and a second capture instruction to multimedia capture device 104. The first and second capture instructions can be sent at the same time or at different times. The first capture instruction can be defined, for example, to trigger multimedia capture device 102 to capture aspects of the business meeting that are different than the aspects that are to be captured by multimedia capture device 104 as defined in the second capture instruction. The first and second capture instructions can be defined, in some embodiments, to include redundant parameters (e.g., both can trigger the capturing of sound). A single capture instruction can also be defined and sent to both multimedia capture devices 102 and 104 in venue A to trigger simultaneous execution of the single capture instruction. For example, a single capture instruction can be defined to trigger both multimedia capture devices 102 and 104 to, for example, stop capturing media signals.

In some embodiments, the multimedia capture devices 102-108 can be dedicated (i.e., specific-purpose) devices having embedded environments (referred to as an embedded appliance). The multimedia capture devices 102-108 can be configured to use a hardened operating system (OS) and a processor (e.g., processor system) to capture, process, store and/or send one or more real-time media signals. The hardened OS is an OS configured to resist security attacks (e.g., prevent access by an unauthorized user or program) and facilitate functions related only to the capturing, processing, storing and/or sending of real-time media signals. In other words, the hardware and software within each of the multimedia capture devices 102-108 can be integrated into and designed specifically for capturing, processing, storing and/or sending real-time media signals.

Because the hardware and software for capturing, processing, storing and/or sending real-time media signals can be integrated into the respective embedded environments of the multimedia capture devices 102-108, the costs and complexity associated with installation, scaling, design, deployment and technical support can be lower than that for general purpose computer systems if performing the same functions as the multimedia capture devices 102-108. More details regarding multimedia capture devices are set forth in co-pending application entitled, “Embedded Appliance for Multimedia Capture” (Attorney Docket No.: ANYS-001/00US) which is incorporated herein by reference.

In some embodiments, one or more of the multimedia capture devices 102-108 can be a general purpose computer system (e.g., personal computer (PC) based multimedia capture device) that is configured to capture a media signal in response to a capture instruction.

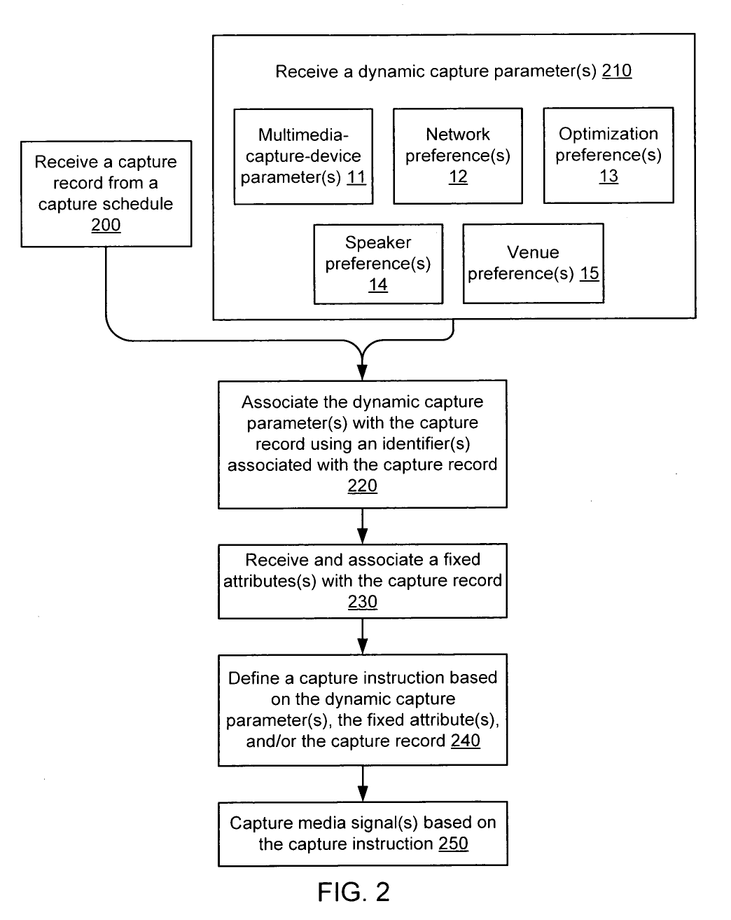

FIG. 2 shows a flowchart that illustrates a method for associating a dynamic capture parameter(s) and a fixed attribute(s) with a capture record from a capture schedule to define a capture instruction. As shown in FIG. 2, a capture record from a capture schedule is received at 200. The capture schedule can be any kind of capture schedule that includes capture records with start time indicators, stop time indicators, and venue indicators that indicate times and venues for capturing one or more media signals by one or more multimedia capture devices.

Although in many embodiments only one start time indicator, one stop time indicator, and one venue indicator correspond with a single capture record, in some embodiments, a capture record can include, for example, recurring start/stop times that are associated with one or more venues (i.e., recurring capture record). For example, a recurring capture record from a university class schedule can specify that a particular class starts/stops at a specified times on, for example, a certain day of the week, every week, for several months. The recurring capture record can be divided into individual capture records for each occurrence (e.g., a single capture record that corresponds to a particular start/stop time and venue) at, for example, a control server before association with a dynamic capture parameter. In some embodiments, a recurring capture record is used to generate one or more capture instructions without dividing the recurring capture record into individual capture records for each occurrence.

As shown in FIG. 2, a dynamic capture parameter(s) is received at 210. The dynamic capture parameter(s) at 210 can be, as an illustrative example, a multimedia-capture-device parameter(s) 11, a network preference(s) 12, an optimization preference(s) 13, a speaker preference(s) 14, and/or a venue preference(s) 15. A storage capacity of a multimedia capture device measured at a given time is an example of the multimedia-capture-device parameter 11. An indicator of the storage capacity can affect, for example, a bit rate, compression, transmission priority or resolution parameter value within a capture instruction. The network preference 12 is a preference defined by, for example, an administrator that is related to, for example, a portion of a network. The network preference 12 can be a general policy set by an administrator that, for example, requires that all video signals being captured by multimedia capture devices not exceed a specified bit rate or disallows the capturing of all video signals on a particular day and/or time. The speaker preference 14 can be, for example, a preference defined by a professor that indicates that a video signal should not be captured by a multimedia capture device when the professor is delivering a lecture at a university. The venue preference 15 is a preference specifying, for example, a specific media sensor within a venue for capturing a media signal.

The optimization preference(s) 13 is a preference that can be defined by, for example, a user or a network administrator and can be used to optimize, improve, and/or modify a parameter value (e.g., capture settings) within a capture instruction. Optimization preference(s) 13 can be used, for example, to optimize, improve, and/or modify values (e.g., bit rate settings) defined in dynamic capture parameters 210 and/or resolve conflicts between dynamic capture parameters 210. Optimization preference(s) 13 can be defined for and/or associated with, for example, a course genre (e.g., mathematics department), a group of speakers, or a content type. Specifically, optimization preference(s) 13 can be defined and used to optimize, improve, and/or modify, for example, a capture instruction for the capturing of a presentation by an art professor that will include high-color photographs and very little motion. A separate optimization preference(s) 13 can be defined for a finance professor (or group of finance professors) to optimize, improve, and/or modify a capture instruction for the capturing of a presentation that will include a Bloomberg terminal with small text that is in constant motion. Other examples of the dynamic capture parameter(s) 210 include, for example, a network parameter (e.g., a measured network capacity).

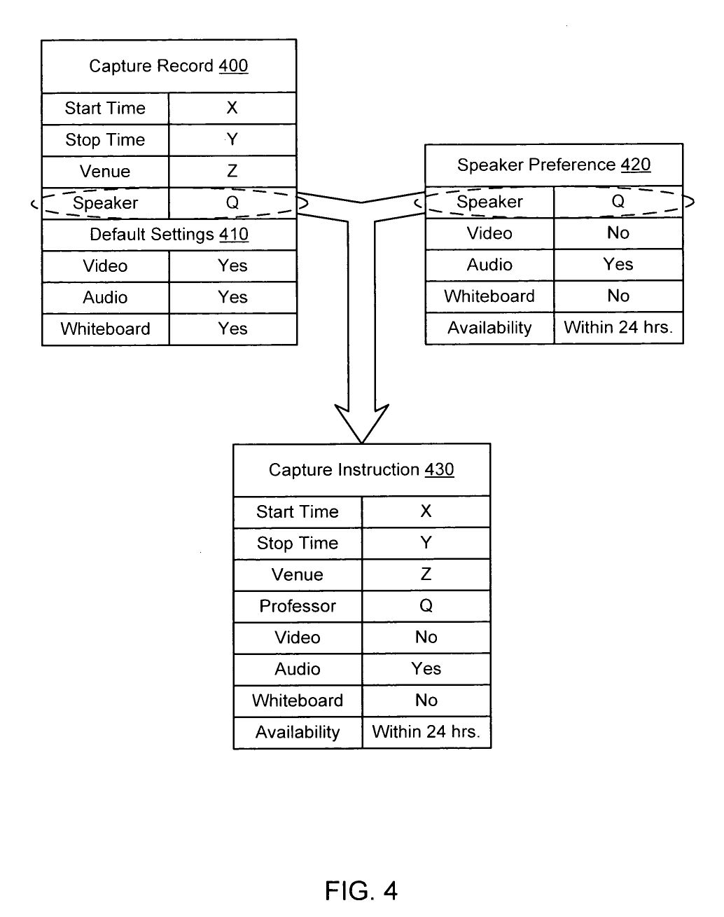

The dynamic capture parameter(s) is associated with the capture record using an identifier(s) associated with the capture record at 220. A venue preference(s) 15, for example, can be associated with the capture record via an identifier such as a venue indicator defined in the capture record. An example of a capture record being associated with a dynamic capture parameter via an identifier is described in more detail below in connection with FIG. 4.

Referring back to FIG. 2, in some embodiments, more than one dynamic capture parameter can be associated with the capture record based on a single identifier included in the capture record. For example, a network preference(s) 12 and a multimedia-capture-device parameter(s) 11 can be associated with the capture record based on a single identifier. In some embodiments, a condition can be defined so that a dynamic capture parameter can be associated with a capture record based on a specified combination of identifiers. For example, a condition can be defined such that the speaker preference(s) 14 is associated with the capture record only when a combination of two specific identifiers are included in the capture record.

In this embodiment, a fixed attribute(s) is received and associated with the capture record at 230. The fixed attribute(s) can be associated with the capture record via one or more identifiers that can be used to link the fixed attribute with the capture record.

As shown in FIG. 2, a capture instruction can be defined based on the dynamic capture parameter(s), the fixed attribute(s), and/or the capture record at 240. Defining the capture instruction includes identifying and resolving any conflicts between the dynamic capture parameter(s), the fixed attribute(s), and the capture record so that a unique value for a particular parameter will be included in the capture instruction. A conflict can arise from, for example, two dynamic capture parameters specifying different values for a particular parameter such as a format for capturing a video signal. In some embodiments, a range of one or more values, if allowed for a particular parameter, can be defined within the capture instruction.

In some embodiments, the capture instruction can be defined to trigger one or more of the multimedia capture devices to, for example, capture only certain portions of media signals (e.g., capture and store sounds received via a microphone while ignoring static and/or silence), capture a video signal or a digital-image signal only when movement or a substantial change in a scene is detected, or capture one or more media signals at variable rates. The capture instruction can include, for example, start and stop capture times that are specific to various input ports that can be included within, for example, a multimedia capture device.

The capture instruction can be defined using, for example, a rules-based algorithm that is implemented as a hardware and/or software module. The rules-based algorithm can be used to, for example, recognize conflicts between values. The rules-based algorithm can also be used to define and/or select one or more values that will be included in a capture instruction. The rules-based algorithm can be configured, for example, so that one or more conflicting values for a parameter within the capture instruction will be selected in view of all of the possible parameter values (including non-conflicting parameter values). For example, the rules-based algorithm can be configured/defined so that one of two conflicting values will be selected based on whether or not video will be captured using a particular media sensor. The rules-based algorithm can be configured, for example, by a network administrator as a default set of rules to be applied in defining one or more capture instructions.

The rules-based algorithm can also be configured to optimize (e.g., improve or modify) parameters/parameter values that are to be included in a capture instruction (e.g., maximize quality, maximize efficiency, minimize file size, etc.). Optimizing includes improving or modifying to a point that is not necessarily the best/optimal point. In some embodiments, the rules-based algorithm can be configured to define, for example, an intermediate value as a compromise between two or more conflicting values. The intermediate value can, for example, be defined as a value that maximizes quality while not exceeding limits imposed by, for example, a particular network preference and/or venue preference.

When a conflict between parameters/parameter values is detected (e.g., a dynamic capture parameter conflict with a fixed attribute), a notification that details the conflict and/or the resolution of the conflict can be sent to, for example, a network administrator and/or other interested party (e.g., user). For example, if the parameter conflict involves a parameter associated with a speaker preference(s) defined by a professor, the notification can be sent to that professor. The notification can detail that, for example, a requested parameter value exceeds the capability of a particular multimedia capture device. A notification can also be sent when, for example, a modified/optimized parameter value or an intermediate parameter value is defined by, for example, a rules-based algorithm.

In some embodiments, the rules-based algorithm can be based on priorities assigned to, for example, dynamic capture parameters, fixed attributes, and/or capture records. For example, a value defined by a dynamic capture parameter and a value defined by a fixed attribute can be resolved by always giving higher priority to the value defined by the fixed attribute. In some embodiments, the priorities can be included in and accessed from a table.

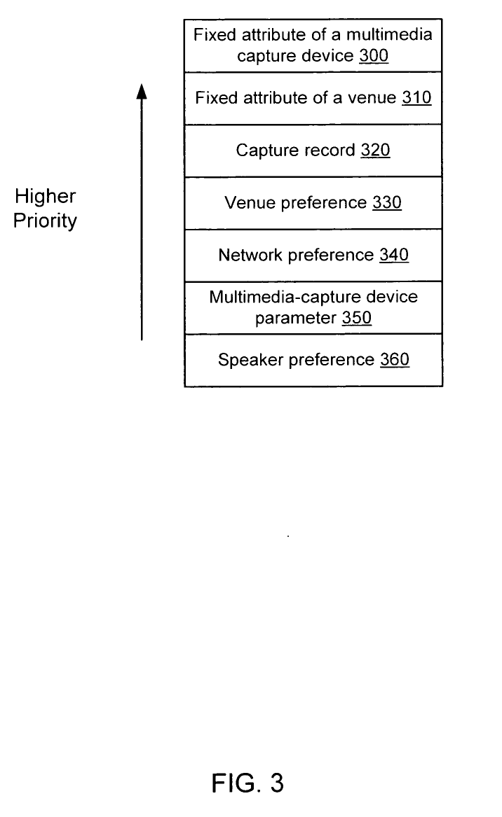

FIG. 3 shows an example priority table that can be used in the definition of a capture instruction. The priority table includes a variety of fixed attributes (e.g., fixed attribute of a venue 310) and dynamic capture parameters (e.g., network preference 340) that are ordered based on a priority to be used when defining a capture instruction. The priority increases from the bottom of the table to the top. The table shows that fixed attributes of a multimedia capture device 300 have the highest priority in defining the capture instruction and that speaker preferences 360 have the lowest priority in defining the capture instruction.

Referring back to FIG. 2, one or more portions of the capture instruction can be, in some embodiments, defined and/or updated as conflicts are identified and resolved. In some embodiments, more than one rules-based algorithm can be used to resolve conflicts and/or define one or more capture instructions for a single or multiple multimedia capture devices. For example, a rules-based algorithm can be configured to define and resolve conflicts between multiple capture instructions associated with more than one multimedia capture device.

In some embodiments, a rules-based algorithm can be used to modify and/or define parameters within a capture instruction even if no conflicts occur between values within the dynamic capture parameter(s), the fixed attribute(s), and/or the capture record. For example, a rules-based algorithm can be used to optimize (e.g., improve or modify) parameters when defining and/or modifying a capture instruction. Because the preferences within an optimization preference(s) 13 and rules within a rules-based algorithm can substantially overlap, the optimization preference(s) 13 can be used in any combination with the rules-based algorithm(s) in optimizing/modifying parameters within a capture instruction. In some embodiments, one or more portions of an optimization preference can take precedent over one or more portions of a rules-based algorithm and vice versa. Conflicts between an optimization preference(s) 13 and a rules-based algorithm(s) can be resolved based on the optimization preference(s) 13 and/or the rules-based algorithm(s). In some embodiments for example, optimization preferences 13 can be configured to be applied according to rules defined in a rules-based algorithm. In some embodiments, the preferences within an optimization preference can take precedent over all corresponding/conflicting rules within, for example, a default set of rules defined in a rules-based algorithm.

After the capture instruction has been defined at 240, the capture instruction can be used by a multimedia capture device to capture one or more media signals based on the capture instruction at 250. In some embodiments, the capture instruction can be modified based on, for example, an updated/modified value within a dynamic capture parameter, fixed attribute, and/or capture record even after the multimedia capture device has commenced capturing one or more media signals.

Although the embodiment illustrated in FIG. 2 includes a particular order for blocks 200-250, the order illustrated in the flowchart is by way of example only and the blocks and/or steps within blocks do not have be executed in that particular order. For example, the dynamic capture parameter(s) received at 210 can be received after the capture record at 200 and even after the fixed attribute(s) is received at 230. In some embodiments, the capture instruction can be initially defined based on only the capture record and the capture instruction can later be modified after the dynamic capture parameter(s) and/or fixed attribute(s) is received. In some embodiments, the capture instruction can be defined based on only the capture record (e.g., defined without a dynamic capture parameter or a fixed attribute).

FIG. 4 illustrates an example of a speaker preference 420 being associated with a capture record 400 via an identifier before a capture instruction 430 is defined. Each of the tables, the capture record 400, the speaker preference 420, and the capture instruction 430, include parameters in their respective left columns (e.g., start time in capture record 400) and parameter values in their respective right columns (e.g., X in capture record 400). The capture record 400 includes a start time X, a stop time Y, a venue Z, and a speaker Q. The capture record 400 also includes default capture settings 410 that specify that video, audio, and whiteboard should be captured. The default capture settings 410 can be defined as global default settings defined by, for example, a network administrator for all capture records within a capture schedule.

The speaker preference 420 indicates, based on the first entry in the speaker preference 420 table, that the speaker preference is associated with speaker Q (e.g., defined by speaker Q). The speaker preference 420 includes preferences that indicate that speaker Q prefers that only audio be captured and that the captured audio should be made available within 24 hours from the time of capture. In some embodiments, the speaker preference can be associated with a group of speakers (e.g., group speaker preference). In some embodiments, more than one speaker identity, in addition to Q, can be included as parameter values.

In the example shown in FIG. 4, the capture record 400 was associated with the speaker preference 420 based on the identity of the speaker as Q. After the association, the figure shows that the parameters/parameter values in the capture record 400 and the parameters/parameter values of the speaker preference 420 are combined to define capture instruction 430. Although not illustrated explicitly in this figure, the capture instruction 430 was defined based on a rules-based algorithm that required that the parameter values within the speaker preference 420 take precedent over the default capture settings 410 within the capture record 400. The default capture settings 410, in this embodiment, were modified to produce a capture setting to be used in the capture instruction 430. The availability parameter in the speaker preference 420, a parameter not included in the capture record 400, was included based on the rules-based algorithm in the capture instruction 430. In some embodiments, default capture settings 410 are not included as part of the capture record 400.

Many combinations of dynamic capture parameters and/or fixed attributes can be associated with, for example, the capture record 400 to define a capture instruction 430. For example, a venue preference for venue Z (not shown) can be associated with the capture record 400 using the parameter value Z of the venue parameter within the capture record 400. Also, for example, a dynamic capture parameter and/or fixed attribute can also be associated with, for example, the availability parameter within the speaker preference 420 to further define the availability included as a parameter/parameter value within the capture instruction 430. In many embodiments, after the capture instruction 430 has been defined, additional and/or modified dynamic capture parameters, fixed attributes, and/or capture records can be associated with parameters/parameter values in the capture instruction 430 to modify the capture instruction 430.

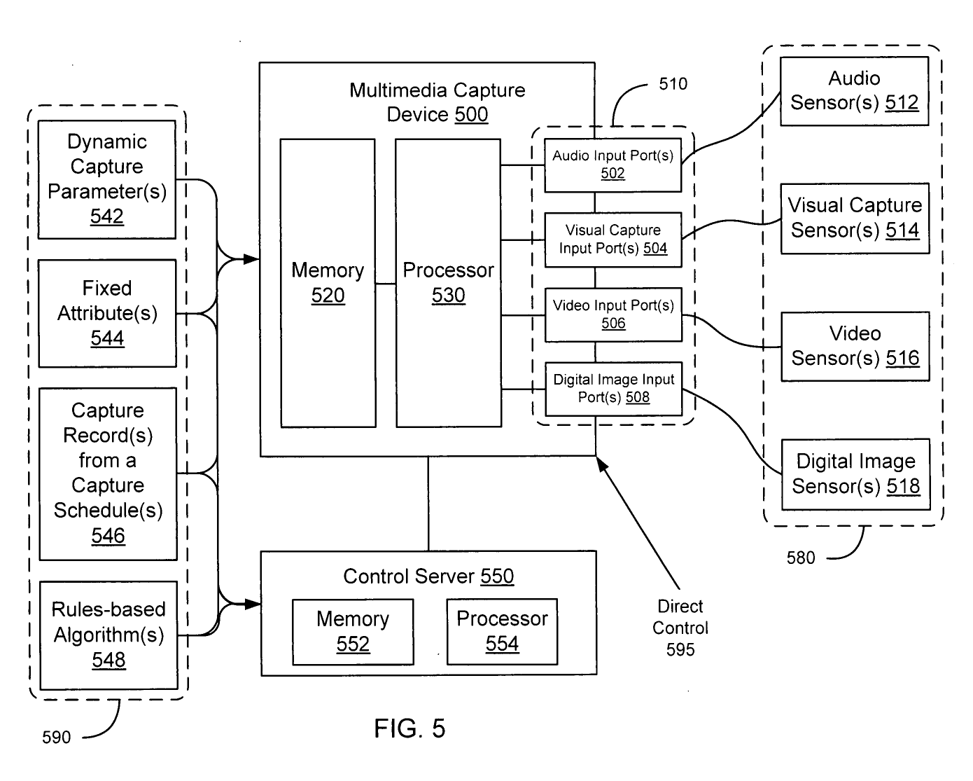

FIG. 5 is a system block diagram that illustrates a multimedia capture device 500 and a control server 500. The multimedia capture device 500 has input ports 510, a memory 520, and a processor 530. The multimedia capture device 500 captures real-time media signals from various media sensors 580 (e.g., electronic devices) via the input ports 510 in response to a capture instruction received at the processor 530. The media signal(s) captured and/or processed at the multimedia capture device 500 can be sent to the control server 550 as, for example, a multiplexed signal over a network connection via an output port (not shown) of multimedia capture device 500.

The input ports 510 include an audio input port(s) 502, a visual-capture input port(s) 504, a video input port(s) 506 and a digital-image input port(s) 508. Each of the input ports 510 are integrated as part of the embedded environment of the multimedia capture device 500. The media signals captured by the inputs ports 510 can be received as an analog signal or as a digital signal. If received as an analog signal, the processor system 550 can convert the analog signal into a digital signal and vice versa.

The audio input port(s) 502 is used to capture an audio signal from an audio sensor(s) 512 such as, for example, a stand alone microphone or microphone connected to a video camera. The visual-capture input port(s) 504 receives a digital or analog video-graphics-array (VGA) signal through a visual capture sensor(s) 514 such as, for example, an electronic whiteboard transmitting images via, for example, a VGA signal. The video input port(s) 506 is configured to receives a video signal from a video sensor 516 such as a video camera. The digital-image input port(s) 508 receives digital-images via a digital image sensor(s) 518 such as, for example, a digital camera or a web camera.

As shown in FIG. 5, capture instruction related information 590 can be received by the multimedia capture device 500 and/or the control server 550. The capture instruction related information 590 includes, for example, a dynamic capture parameter(s) 542, a fixed attribute(s) 544, a capture record(s) from a capture schedule(s) 546, and/or a rules-based algorithm(s) 548 (e.g., priority table). Because the capture instruction related information 590, can be stored and/or received at the multimedia capture device 500 and/or the control server 550, one or more capture instructions or portions of the capture instructions can be defined and/or modified at the multimedia capture device 500 and/or the control server 550. After being defined/modified at the multimedia capture device 500 and/or control server 550, the capture instruction can then be received and/or used by the processor 530 of the multimedia capture device 500 to capture one or more media signals.

For example, the capture instruction can be initially defined at the control server 550 and further defined/modified at the multimedia capture device 500 and vice versa. The modification can be based on, for example, an updated dynamic capture parameter. Any portion of the capture instruction related information 590 can be transmitted between the control server 550 and the multimedia capture device 500 to facilitate the defining and/or modifying of the capture instruction at the multimedia capture device 500 and/or the control server 550. In some embodiments, capture instruction related information 590 can be stored in a component such as, for example, a server (not shown) that can be accessed by the control server 550 and/or the multimedia capture device 500. In some embodiments, the control server 550 can broadcast capture instruction related information 590 to more than one multimedia capture device.

Specifically, the processor 530 of the multimedia capture device 500 can be used to define/modify the capture instruction using information received at the processor 530 and/or accessed from the memory 520. The processor 554 of the control server 550, like the processor 530 in the multimedia capture device 500, can be used to define/modify one or more capture instruction(s) using information received at the processor 554 and/or accessed from the memory 552. The memory 520 of the multimedia capture device 500 and/or the memory 552 of the control server 550 can be used, for example, to store the capture instruction related information 590.

One or more parameters within the capture instruction can be dynamically modified at the multimedia capture device 500 and/or the control server 550 up until and even after the multimedia capture device 500 begins capturing media signals based on the capture instruction. The dynamic modification can be triggered by a change to any portion of the capture instruction related information 590.

In some embodiments, the processor 530 can include other software and/or hardware modules to perform other processing functions such as, for example, encoding, decoding, indexing, formatting and/or synchronization of media signals. The hardware components in the processor 530, which can include, for example, application specific integrated circuits (ASICs), central processing units (CPUs), modules, digital signal processors (DSPs), processors and/or co-processors, are configured to perform functions specifically related to capturing, processing, storing and/or sending media signals. In some embodiments, the processor 530 can be a processor system having multiple processors.

After the real-time media signal(s) are captured, the multimedia capture device 550 can be configured to process the signal(s) by, for example, compressing, indexing, encoding, decoding, synchronizing and/or formatting their content for eventual retrieval by a user (not shown) from, for example, a server(s) (not shown) configured as a course management system. In some embodiments, a capture instruction can be defined to trigger the processing of media signals in any combination of formats.

Although FIG. 5 shows only a single control server 550 connected with multimedia capture device 500, in some embodiments, more than one control server (not shown) in addition to control server 550 can be connected with several multimedia capture devices (not shown) in addition to multimedia capture device 500. For example, a second control server (not shown) and control server 550 can be configured to coordinate the capturing, processing, storing and/or sending of media signals captured by the several multimedia capture devices and/or multimedia capture device 500. In some embodiments, multimedia capture device 550 can be configured to recognize multiple control servers and can be configured to respond to one or more capture instructions from multiple control servers. Multimedia capture device 550 can also be configured to respond to capture instructions sent from one or more specified control servers (not shown) from a group of control servers (not shown).

FIG. 5 also illustrates that the multimedia capture device 500 can be controlled using a direct control signal 595 from, for example, a user (not shown). The multimedia capture device 500 can include an interface such as a graphical user interface (GUI) (not shown), physical display (not shown) or buttons (not shown) to produce the direct control signal 595 to, for example, modify and/or override a capture instruction. The direct control signal 595 can also be used to, for example, modify a capture schedule and/or a capture record stored on the multimedia capture device 500 The multimedia capture device 500 can be configured to require authentication (e.g., username/password) of, for example, a user before accepting a direct control signal 595 sent via an interface (not shown) from the user. The direct control signal 530 can also be generated using, for example, an interface (not shown) that is not directly coupled to the multimedia capture device 500.

In conclusion, among other things, an apparatus and method for defining parameters for capturing media signals on a multimedia capture device is described. While various embodiments of the invention have been described above, it should be understood that they have been presented by way of example only and various changes in form and details may be made. For example, a first processor within a multimedia capture device can be configured to define capture instructions and a second processor can be used to modify capture instructions.

What is claimed is:

1. A method, comprising:
modifying a capture instruction at a processor of a multimedia capture device at a first time to produce a modified capture instruction, the capture instruction being defined at a second time different from the first time and based on a first dynamic capture parameter, the modifying being based on at least one of a change to a parameter value within the first dynamic capture parameter or a second dynamic capture parameter; and
sending a control signal from the multimedia capture device to a media sensor based on the modified capture instruction, the control signal configured to cause the media sensor to acquire a media signal.

2. The method of claim 1, further comprising processing the media signal at the multimedia capture device based on the capture instruction.

3. The method of claim 1, wherein the at least one of the change or the second dynamic capture parameter are associated with the capture record based on an identifier included in the capture record.

4. The method of claim 1, wherein the capture instruction is defined based on a rules-based algorithm.

5. The method of claim 1, wherein the capture instruction is defined using at least one of a control server or the multimedia capture device.

6. The method of claim 1, wherein the multimedia capture device is a specific-purpose embedded appliance that includes a processor system.

7. The method of claim 1, wherein the multimedia capture device is a general purpose computer system configured for media signal capture.

8. The method of claim 1, wherein the media signal includes at least one of an audio signal, a video signal, a visual-capture signal or a digital-image signal.

9. The method of claim 1, wherein the first dynamic capture parameter is at least one of a multimedia-capture-device parameter associated with the multimedia capture device, a network preference associated with at least a portion of the network, a venue attribute associated with a venue, or a speaker preference associated with a speaker.

10. The method of claim 1, wherein the second dynamic capture parameter is at least one of a multimedia-capture-device parameter associated with the multimedia capture device, a network preference associated with at least a portion of the network, a venue attribute associated with a venue, or a speaker preference associated with a speaker.

11. A method, comprising:
associating a dynamic capture parameter with a capture record included in a capture schedule; and
defining a capture instruction based on the dynamic capture parameter and the capture record, the capture instruction configured to cause a multimedia capture device to capture a media signal after the capture instruction is received at the multimedia capture device.

12. The method of claim 11, wherein the defining includes defining using at least one of a control server or the multimedia capture device,
the method, further comprising:
sending the capture instruction to a processor of the multimedia capture device.

13. The method of claim 11, wherein the multimedia capture device is a first multimedia capture device, the defining includes defining the capture instruction for a second multimedia capture device.

14. The method of claim 11, further comprising associating the dynamic capture parameter with a second capture record included in the capture schedule.

15. The method of claim 11, wherein the associating includes associating based on an identifier associated with the capture record.

16. The method of claim 11, wherein the dynamic capture parameter is at least one of a multimedia-capture-device parameter associated with the multimedia capture device or a network-preference associated with the network.

17. The method of claim 11, wherein the dynamic capture parameter is a speaker preference associated with a speaker, the associating includes associating based on an identifier associated with the speaker.

18. The method of claim 11, wherein the dynamic capture parameter is a venue preference associated with a venue.

19. The method of claim 11, wherein the capture record is associated with a default capture setting that is modified based on the dynamic capture parameter to produce a capture setting, the capture instruction includes at least a portion of the capture setting.

20. The method of claim 11, wherein the multimedia capture device is at least one of a specific-purpose embedded appliance having an embedded environment or a general purpose computer system configured for media signal capture.

21. The method of claim 11, wherein the media signal is at least one of an audio signal, a video signal, a visual-capture signal or a digital-image signal.

22. The method of claim 11, wherein the defining includes defining at a first time,
the method, further comprising:
modifying the capture instruction at a second time different from the first time based on a change to a parameter within the dynamic capture parameter.

23. The method of claim 11, wherein the multimedia capture device is triggered by a parameter within the capture instruction to send a control signal that prompts a media sensor to acquire the media signal.

24. A method, comprising:
associating a first dynamic capture parameter with a capture record from a plurality of capture records within a capture schedule;
associating a second dynamic capture parameter with the capture record; and
sending a capture instruction to a processor of a multimedia capture device, the capture instruction being based on the first dynamic capture parameter and the second dynamic capture parameter, the capture instruction being configured to cause the multimedia capture device to schedule capture of a media signal.

25. The method of claim 24, wherein the capture instruction is generated based on a priority of the first dynamic capture parameter and a priority of the second dynamic capture parameter.

26. The method of claim 24, wherein the capture instruction is generated based on a rules-based algorithm.

27. The method of claim 24, wherein the associating the first dynamic capture parameter includes associating based on a first identifier associated with the capture record, the associating the second dynamic capture parameter includes associating based on a second identifier associated with the capture record.

28. The method of claim 24, further comprising associating a fixed attribute with the capture record, the capture instruction being based on the fixed attribute.

29. The method of claim 24, further comprising sending a notification when a conflict between a portion of the first dynamic capture parameter and a portion of the second dynamic capture preference is at least one of detected or resolved.

30. The method of claim 24, wherein the multimedia capture device is at least one of a specific-purpose embedded appliance that includes a processor system or a general purpose computer system configured for media signal capture.

31. The method of claim 24, wherein the media signal includes at least one of an audio signal, a video signal, a visual-capture signal or a digital-image signal.
